(19) United States
(12) Patent Application Publication
(10) Pub. No.: US 2007/0070110 A1
(43) Pub. Date: Mar. 29, 2007

(54) Apparatus and method of testing printhead nozzle

(75) Inventor: Jung-hwan Kim, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/501,860

(22) Filed: Aug. 10, 2006

(30) Foreign Application Priority Data
Sep. 23, 2005 (KR) 2005-88684

(51) Int. Cl. B41J 29/393

(52) U.S. Cl. 347/19

(57) ABSTRACT

An apparatus and method of testing a printhead nozzle includes a power supply unit to supply a power to the printhead, a capacitor to stabilize a voltage of the power supply unit so that the power supply unit supplies a constant power to the printhead, a voltage sensing unit to sense a voltage of the capacitor, a nozzle testing unit to test the nozzle using the sensed voltage to detect an abnormal condition of the nozzle, and a control unit to control driving of the power supply unit and the nozzle.

### CROSS-REFERENCE TO RELATED APPLICATIONS

This application claims priority from Korean Patent Application No.10-2005-0088684, filed on Sep. 23, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an apparatus and method of testing a nozzle of a printhead in a full page width printer by sensing a voltage of a capacitor or calculating a rate of change of the voltage of the capacitor, wherein the capacitor is used to stabilize a voltage of power supplied to the printhead to drive the nozzle.

2. Description of the Related Art

Generally, to detect an abnormal condition of nozzles or a defective nozzle in a conventional printhead as illustrated in FIG. 1, additional components or circuits such as an optical sensor sensing an operational state of a nozzle driving circuit are used. Otherwise, an additional process is performed in a printhead manufacturing process to test the nozzles of the printhead.

Thus, in the former case, manufacturing costs of the printhead are high, and in the latter case, a manufacturing process of the printhead becomes complicated and a manufacturing time thereof increases.

### SUMMARY OF THE INVENTION

The present general inventive concept provide s an apparatus and method of testing a nozzle of a printhead by sensing a voltage of a capacitor or calculating a rate of change of the voltage of the capacitor, wherein the capacitor is used to stabilize a voltage of a power supply unit to supply a power to the printhead to drive the nozzle.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an apparatus to test a nozzle of a printhead, the apparatus comprising a power supply unit to supply a power to the printhead, a capacitor to stabilize a voltage of the power supplied to the printhead, a voltage sensing unit to sense a voltage of the capacitor, a nozzle testing unit to test the nozzle using the sensed voltage to detect an abnormal condition of the nozzle, and a control unit to control driving of the power supply unit and the nozzle.

The control unit may output a first control signal to stop supplying the power to the printhead when the sensed voltage is greater than a predetermined voltage and output a second control signal to control the driving of the nozzle when a predetermined period of time has passed after the first control signal has been output.

The nozzle testing unit may comprise a voltage input unit to receive sensed voltages of the capacitor before and after the nozzle is driven, and a defective nozzle detecting unit to detect an abnormal condition of the nozzle using the received voltages.

The defective nozzle detecting unit may detect the abnormal condition of the nozzle using a difference between the voltage sensed before the nozzle is driven and the voltage sensed after the nozzle is driven.

The defective nozzle detecting unit may detect the abnormal condition of the nozzle if the difference between the voltage sensed before the nozzle is driven and the voltage after the nozzle is driven is greater than a critical value.

The foregoing and/or other aspects of the present general inventive concept may also be achieved by providing an apparatus to test a nozzle of a printhead, the apparatus comprising a power supply unit to supply a power to the printhead, a capacitor to stabilize the voltage of the power supplied to the printhead and to output the voltage to the printhead, a rate of change calculating unit to sense a voltage of the capacitor to calculate a rate of change of the voltage, and a defective nozzle detecting unit to detect an abnormal condition of the nozzle using the calculated rate of change of the voltage.

The rate of change calculating unit may calculate the rate of change of the voltage by sensing the voltage of the capacitor during driving of the nozzle.

The defective nozzle detecting unit may detect an abnormal condition of the nozzle by determining whether an inclination of the calculated rate of change is greater than a critical inclination.

The foregoing and/or other aspects of the present general inventive concept may also be achieved by providing a method of testing a nozzle of a printhead of an image forming apparatus including a capacitor to stabilize a voltage of power supplied to the printhead, the method comprising supplying a power to the printhead, stopping the supplying of power when a voltage of the capacitor is larger than a predetermined voltage, measuring voltages of the capacitor before the nozzle is driven and after the nozzle is driven, and determining whether the nozzle is in an abnormal condition using the measured voltages.

The determining may comprise determining whether a voltage difference between the voltage measured before the nozzle is driven and the voltage measured after the nozzle is driven is greater that a critical voltage, and deciding that the nozzle is in an abnormal condition if the voltage difference is larger than the critical voltage.

The foregoing and/or other aspects of the present general inventive concept may also be achieved by providing computer readable medium having embodied thereon a computer program for executing the method above.

The foregoing and/or other aspects of the present general inventive concept may also be achieved by providing a method of testing a nozzle of a printhead of an image forming apparatus including a capacitor to stabilize a voltage of power supplied to the printhead, the method comprising supplying a power to the printhead, stopping the supplying of the power when a voltage of the capacitor is larger than a predetermined voltage, measuring a rate of change of the voltage by driving the nozzle in the printhead, and determining whether the nozzle is in an abnormal condition using the measured rate of change.

The determining may comprise comparing an inclination of the measured rate of change and a critical inclination, and determining that the nozzle is in the abnormal condition when the inclination of the measured rate of change is greater than the critical inclination.

The foregoing and/or other aspects of the present general inventive concept may also be achieved by providing a computer readable medium having embodied thereon a computer program for executing the method above.

The foregoing and/or other aspects of the present general inventive concept may also be achieved by providing a image forming apparatus comprising a power supply unit, a printhead having one or more nozzles, a capacitor connected between the power supply unit and the printhead to supply a voltage to the printhead, and a determining unit to determine an abnormal condition of the printhead according to a change of the voltage of the capacitor.

The foregoing and/or other aspects of the present general inventive concept may also be achieved by providing a image forming apparatus comprising a power supply unit to generate a power, a printhead having one or more nozzles, a capacitor unit connected between the power supply unit and the printhead to supply a voltage of the power to the printhead, a switch unit connected between the power supply unit and the capacitor unit to selectively supply the power to the capacitor according to the voltage of the capacitor unit, a determining unit to detect a change of the voltage of the capacitor determining unit, and to determine the abnormal condition of the one or more nozzles of the printhead according to the change of the voltage of the capacitor with respect to a predetermined period of time, and a control unit to control the switch unit and the printhead according to the change of the voltage of the capacitor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a conventional printhead;

FIG. 2 is a block diagram of an apparatus to test a printhead nozzle according to an embodiment of the present general inventive concept;

FIGS. 3A, 3B, and 3C are graphs illustrating time variations of a voltage of a capacitor in the apparatus of FIG. 2;

FIG. 4 is a circuit diagram illustrating the apparatus of FIG. 2;

FIGS. 5A and 5B are flowcharts illustrating a method of testing a nozzle according to an embodiment of the present general inventive concept;

FIGS. 6A and 6B are flowcharts illustrating a method of testing a group of nozzles according to an embodiment of the present general inventive concept; and

FIGS. 7A and 7B are flowcharts illustrating a method of testing a nozzle according to an embodiment of the present general inventive concept.

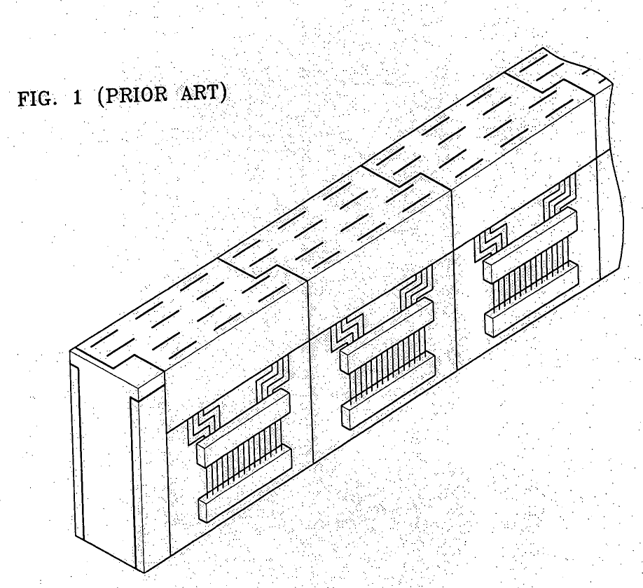

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

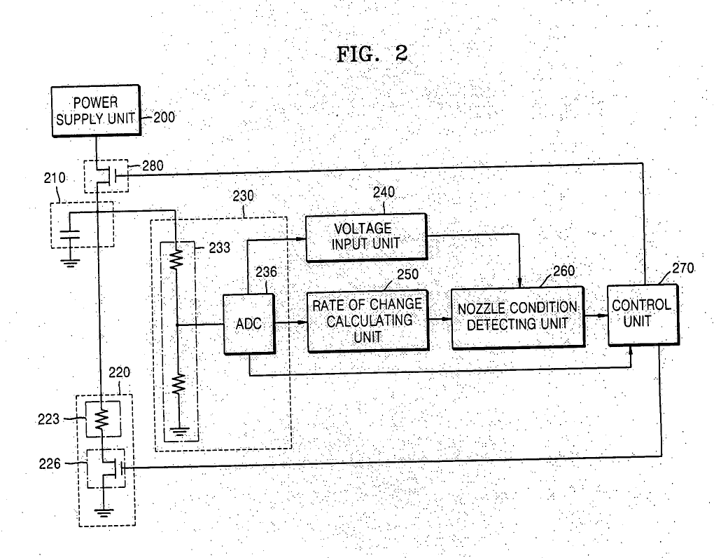

FIG. 2 is a block diagram illustrating an apparatus to test a printhead nozzle according to an embodiment of the present general inventive concept. The nozzle testing apparatus is used in conjunction with a printhead 220 and includes a power supply unit 200, a capacitor 210, a voltage sensing unit 230, a voltage input unit 240, a rate of change calculating unit 250, a defective nozzle detecting unit 260, and a control unit 270. The voltage sensing unit 230, the voltage input unit 240, and the rate of change calculating unit 250 may be referred to as a detecting unit to detect a change of a voltage thereof. The detecting unit and the control unit 270 may be referred to as a determining unit to determine a condition of the printhead.

The power supply unit 200 supplies a power to the printhead 220 to drive one or more nozzles (not shown) formed in the printhead 220. The capacitor 210 is connected between a potential and a line connecting the power supply unit 200 and the printhead 220 to stabilize a voltage of the power supply unit 200 to compensate for temporary voltage drops and control the power supply unit 220 to transfer a constant power to the printhead 220 since the voltage of the power supply unit 200 does not vary by more than plus/minus 2% of a desired or required voltage. The printhead 220 includes a heater 223 and a second switch 226. The heater 223 is disposed in an ink chamber or a layer of the printhead to generate heat in response to the power supplied by the power supply unit 220 so that ink is ejected through the nozzles on a printing medium.

The second switch 226 switches (turns on and off) the heater 223 according to a control signal output from the control unit 270. The voltage sensing unit 230 senses the stabilized voltage of the capacitor 210. The voltage sensing unit 230 includes a voltage dividing unit 233 and an analog-to-digital converter (ADC) 236. The voltage dividing unit 233 includes a plurality of resistances to divide and output the voltage stabilized by the capacitor 210. The ADC 236 converts an analog value of the voltage output by the voltage dividing unit 233 into a digital value. The voltage input unit 240 receives digital voltages (i.e., digital value) converted before and after the heater 223 of the nozzles in the printhead 220 is driven. Then, the rate of change calculating unit 250 receives the digital voltages converted in the ADC 236 before and after the heater 223 is driven and calculates the rate of change of the voltages.

The defective nozzle detecting unit 260 detects an abnormal condition of the nozzles by determining whether a voltage difference between the digital voltages before and after the heater 223 is driven is greater than a critical voltage. The defective nozzle detecting unit 260 determines that the nozzles are in a normal condition when the voltage difference received from the voltage input unit 240 is greater than the critical voltage.

Furthermore, the defective nozzle detecting unit 260 detects the condition of the nozzles by estimating whether an inclination of the rate of change of the voltages calculated in the rate of change calculating unit 250 is greater than a critical inclination. Otherwise, the defective nozzle detecting unit 260 determines that the nozzles are in a normal condition when the inclination of the rate of change of the voltage calculated in the rate of change calculating unit 250 is smaller than the critical inclination.

A first switch 280 is disposed between the power supply unit 200 and a junction of the capacitor 210 and the printhead 220 to operate in response to a control signal output from the control unit 270 to control the power supply unit 200 supplying power to the printhead 220.

The control unit 270 controls the power supply unit 200 and the driving of the heater 223 in response to a detection result of the defective nozzle detecting unit 260 to control the printhead 220. The control unit 270 receives the digital voltage from the ADC to determine whether the printhead is short-circuited before driving the printhead 220.

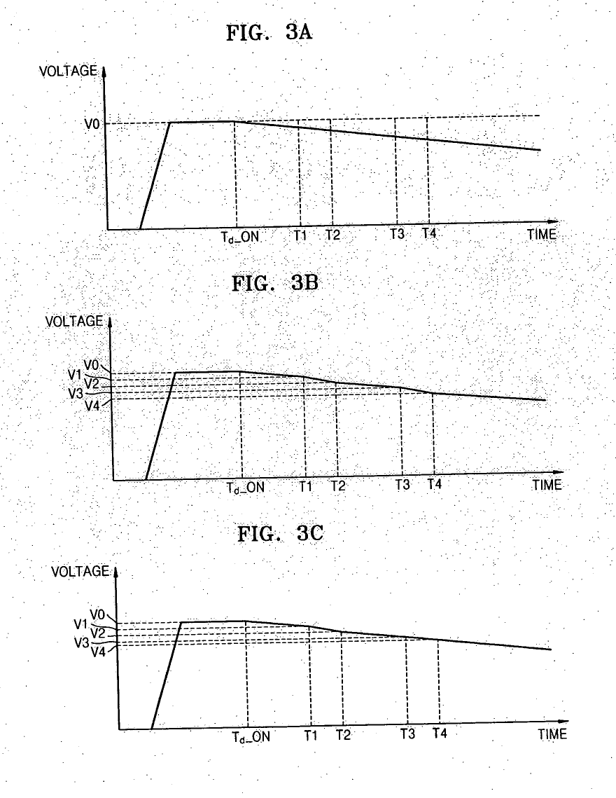

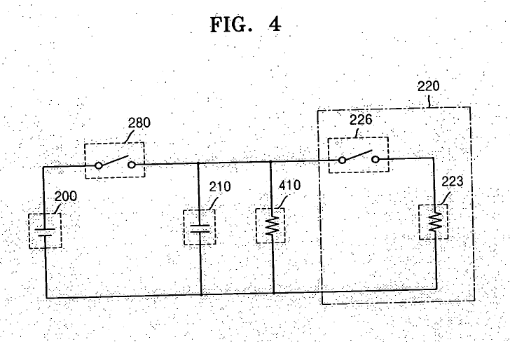

FIGS. 3A, 3B, and 3C are graphs illustrating the voltage of the capacitor 210 according to time variation of FIG. 2. FIG. 4 is a view illustrating a circuit diagram of the apparatus of FIG. 2.

Referring to FIGS. 3A-4, when the first switch 280 is closed, the capacitor 210 is charged according to the following equation:

$$v ( t ) = Vph ( 1 - {ɛ}^{- \frac{1}{Rload \times C} \times t} ) \qquad [ Equation 1 ]$$

where v(t) is the voltage of the capacitor 210 during time t, Vph is the voltage supplied from the power supply unit 200, Rload is a resistance of the resistor 410, and C is a capacitance of the capacitor 310.

When the first switch 280 is opened, the capacitor 210 is discharged according to the following equation:

$$v ( t ) = Vph \times {ɛ}^{- \frac{1}{Rload \times C} \times t} \qquad [ Equation 2 ]$$

FIG. 3A is a graph illustrating the voltage of the capacitor 210 according to the time variation when nozzles 1 and 2 in the printhead 220 are in an abnormal condition.

When a cartridge included in the printhead is not short-circuited, the capacitor 210 is charged until time Td_ON according to Equation 1. Although the nozzle 1 is driven between times T1 and T2 and the nozzle 2 is driven between times T3 and T4, since the nozzles 1 and 2 are both in the abnormal condition, a natural discharge of the capacitor 210 appears according to Equation 2.

FIG. 3B is a graph illustrating the voltage of the capacitor 210 according to the time variation when the nozzles 1 and 2 are in a normal condition.

The capacitor 210 is forced to discharge when the nozzle 1 is driven between times T1 and T2 and the nozzle 2 is driven between times T3 and T4. Thus, the voltage difference between the voltages of the capacitor 210 before and after the nozzles 1 and 2 are driven becomes greater.

FIG. 3C is a graph illustrating the voltage of the capacitor 210 according to the time variation when the nozzle 1 is in the normal condition and the nozzle 2 is in the abnormal condition.

The nozzle 1 is driven between times T1 and T2 to force the capacitor 210 to discharge, and thus, the voltage difference between the voltages of the capacitor 210 before and after the nozzles 1 and 2 are driven becomes greater. However, even though the nozzle 2 is driven between times T3 and T4, the nozzle 2 is in an abnormal condition, and thus a natural discharge of the capacitor 210 appears.

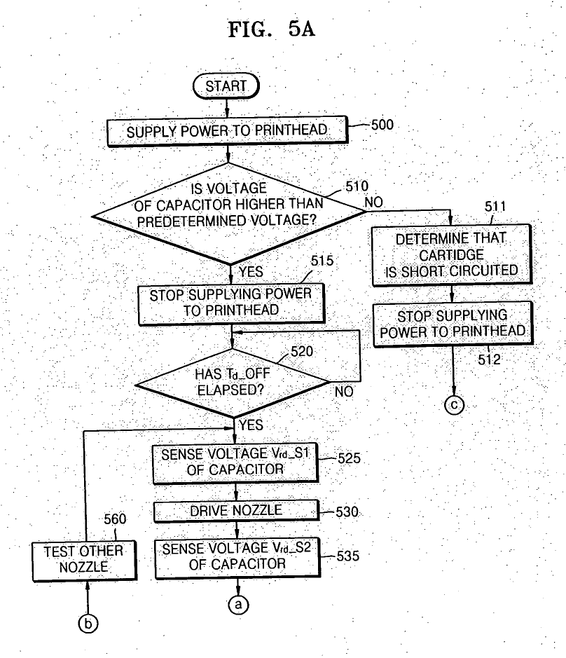

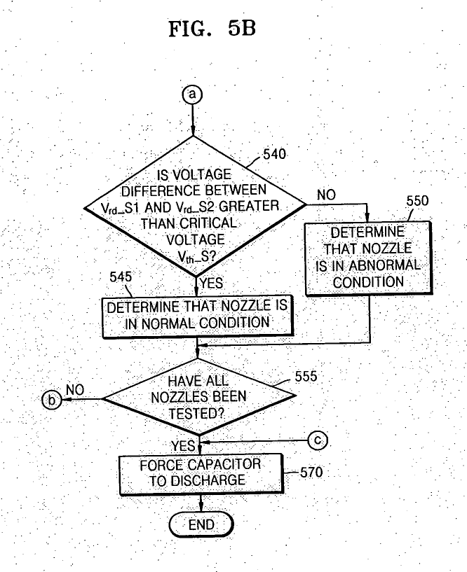

FIGS. 5A and 5B are views illustrating a method of testing a nozzle of a printhead according to an embodiment of the present general inventive concept.

First, in operation 500, a power supply unit drives a printhead. In the operation 500, since a voltage of the power supply unit may not vary by more than plus/minus 2 % of a desired or required voltage, an apparatus to test one or more nozzles includes a capacitor to compensate for temporary voltage drops of the power supply unit and control the power supply unit to transfer a constant power to the printhead.

In operation 510, it is determined whether the voltage of the capacitor is larger a predetermined voltage.

In the operation 511, if the voltage of the capacitor is not larger than the predetermined voltage in the operation 510, the cartridge is considered to be short-circuited.

In operation 512, the power supply unit stops driving the printhead. Then, in operation 570, the capacitor is forced to discharge.

In operation 515, if the voltage of the capacitor is larger than the predetermined voltage in the operation 510, the power supply unit stops driving the printhead.

After the operation 515, in operation 520, it is determined whether a time Td_OFF has elapsed.

In operation 525, if it was determined in the operation 520 that the time Td_OFF has elapsed, the voltage Vrd_S1 of the capacitor is sensed.

Then, in operation 530, a nozzle to be tested is driven. The nozzle may be a single nozzle of the printhead.

In operation 535, the voltage Vrd_S2 of the capacitor is sensed.

In operation 540, it is checked whether a voltage difference Vd between the voltages Vrd_S1 and Vrd_S2 is greater than a critical voltage Vth_S.

In operation 545, if the voltage difference Vd is greater than the critical voltage Vth_S in operation 540, the tested nozzle is determined to be in a normal condition. The voltage difference Vd in the operations 540 and 545 corresponds to the voltage differences in intervals (T1,T2) in FIG. 3B, (T3,T4) in FIG. 3B, and (T1,T2) in FIG. 3C.

In operation 550, if the voltage difference Vd is smaller than the critical voltage Vth_S in the operation 540, the tested nozzle is determined to be in an abnormal condition. The voltage difference in the operations 540 and 550 corresponds to the voltage differences in intervals (T1,T2) in FIG. 3A, (T3,T4) in FIG. 3A, and (T3 ,T4) in FIG. 3C.

In operation 555, it is checked whether all nozzles of the pinhead have been tested.

In operation 560, if it was determined in the operation 555.that not all of the nozzles have been tested, other nozzles are set for testing and the operations 525 through 555 are repeated with respect to the other nozzles.

In the operation 570, if it was determined in the operation 555 that all of the nozzles have been tested, the capacitor is forced to discharge.

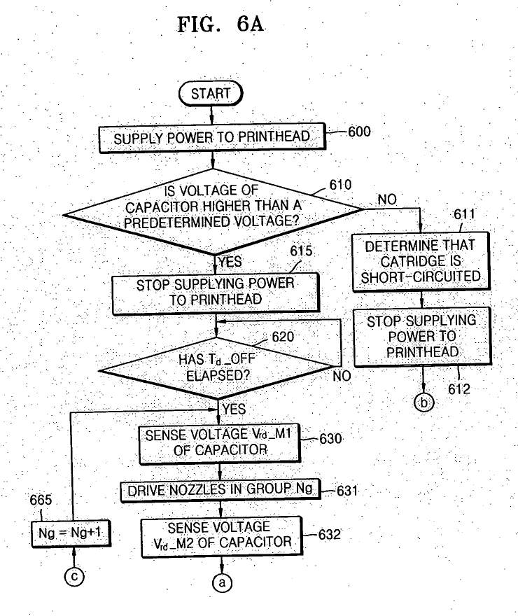

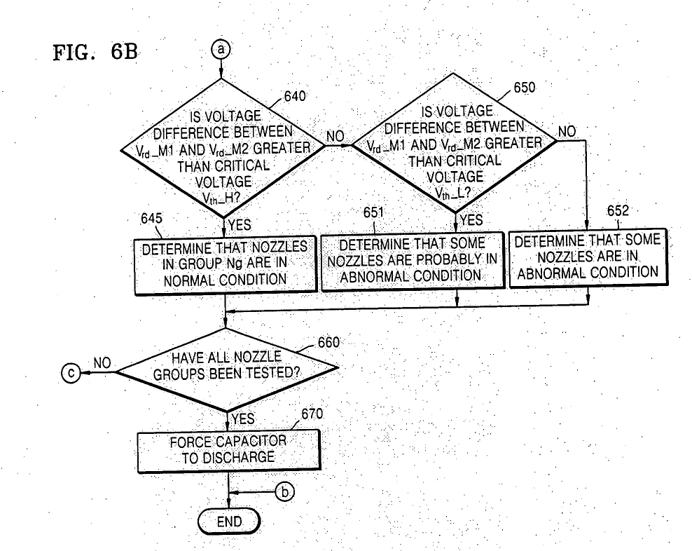

FIGS. 6A and 6B are flowcharts illustrating a method of testing s group of nozzles according to an embodiment of the present general inventive concept.

First, in operation 600, a power supply unit drives a printhead. In the operation 600, since the voltage of the power supply unit may not vary by more than plus/minus 2% of a desired or required voltage, an apparatus to test the nozzles includes a capacitor to compensate for temporary voltage drops of the power supply unit and control the power supply unit to transfer a constant power to the printhead.

In operation 610, it is determined whether the voltage of the capacitor is larger than a predetermined voltage.

In operation 611, if the voltage of the capacitor is not larger than the predetermined voltage in the operation 610, the cartridge is considered to be short-circuited.

In operation 612, the power supply unit stops driving the printhead. Then, in operation 670, the capacitor is forced to discharge.

In operation 615, if the voltage of the capacitor is larger than the predetermined voltage in the operation 610, the power supply unit stops driving the printhead. After the operation 615, in operation 620, it is determined whether a time Td_OFF has elapsed.

In operation 630, if it was determined in the operation 620 that the time Td_OFF has passed, the voltage Vrd_M1 of the capacitor is sensed.

In operation 631, nozzles in a group Ng to be tested are driven. Nozzles in the printhead are grouped in a predetermined number of groups, each group including a predetermined number of nozzles, and a first group of nozzles to be tested has an index 1 which is set to 1 as a value of Ng.

In operation 632, the voltage of the capacitor Vrd_M2 is sensed.

In operation 640, it is checked whether the voltage difference Vd between the voltages Vrd_M1 and Vrd_M2 is greater than a critical voltage Vth_H.

In operation 645, if it was determined in the operation 640 that the voltage difference Vd is greater than the critical voltage Vth_H, the nozzles in the tested group Ng with index 1 are determined to be in a normal condition.

In operation 650, if it was determined in the operation 640 that the voltage difference Vd is not greater than the critical voltage Vth_H, it is checked whether the voltage difference Vd is greater than a critical voltage Vth_L.

In operation 651, if it was determined in the operation 650 that the voltage difference Vd is greater than the critical voltage Vth_L, it is determined that one or more nozzles in the tested group Ng might be in an abnormal condition.

In operation 652, if it was determined in the operation 650 that the voltage difference Vd is not greater than the critical voltage Vth_L, it is determined that several nozzles in the tested group Ng are in an abnormal condition.

In operation 660, after the operations 645, 651, or 652, it is checked whether all of the nozzle groups Ng have been tested.

In operation 665, if it was determined in the operation 660 that not all of the nozzle groups Ng have been tested, the index of the nozzle group Ng is increased by 1 and the operations 630 through 652 are repeated for a next nozzle group Ng+1.

If it was determined in the operation 660 that all of the nozzle groups Ng have been tested, in operation 670, the capacitor is forced to discharge.

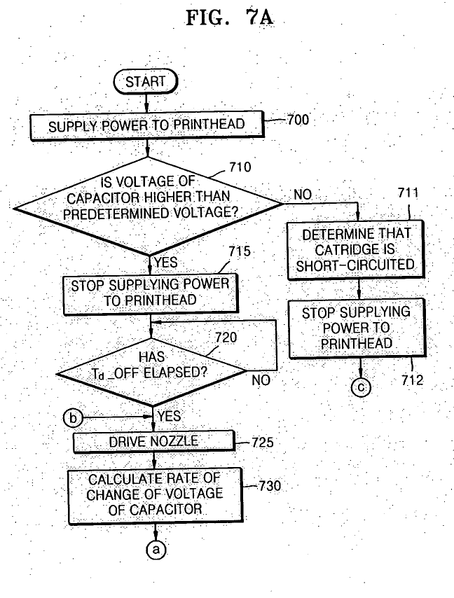

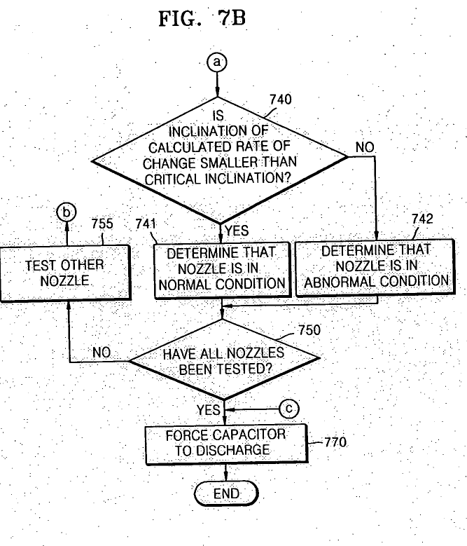

FIGS. 7A and 7B are flowcharts illustrating a method of testing a nozzle according to another embodiment of the present general inventive concept.

First, in operation 700, power is supplied to a printhead. In the operation 700, since the voltage of the power supply unit may not vary by more than plus/minus 2% of a desired or required voltage, an apparatus to test one or more nozzles includes a capacitor to compensate for temporary voltage drops of the power supply unit and control the power supply unit to transfer constant power to the printhead.

In operation 710, it is checked whether the voltage of the capacitor is larger than a predetermined voltage.

In operation 711, if the voltage of the capacitor is not higher than the predetermined voltage in the operation 710, the cartridge is considered to be short-circuited.

In operation 712, the power supply unit stops supplying the power to the printhead.

In operation 715, if the voltage of the capacitor is larger than the predetermined voltage in the operation 710, the power supply unit stops driving the printhead.

In operation 720, it is checked whether a time Td_OFF has elapsed.

In operation 725, if it was determined in the operation 720 that the time Td_OFF has elapsed, the nozzle to be tested is driven.

In operation 730, the voltage of the capacitor is sensed while the nozzle being tested is driven.

In operation 740, it is checked whether an inclination of a calculated rate of change of the capacitor is smaller than a critical inclination.

In operation 741, if it was determined in the operation 740 that the calculated rate of change of the capacitor is smaller than the critical inclination, the tested nozzle is considered to be in a normal condition.

In operation 742, if it was determined in the operation 740 that the calculated rate of change of the capacitor is not smaller than a critical inclination, the tested nozzle is considered to be in an abnormal condition.

After the operations 741 or 742, in operation 750, it is checked whether all the nozzles have been tested.

If it was determined in the operation 750 that not all the nozzles have been tested, another nozzle to be tested is driven in operation 755, and the operations 725 through 750 are repeated.

If it was determined in the operation 750 that all the nozzles have been tested, in the operation 770, the capacitor is forced to discharge.

The above-illustrated method can also be embodied as computer readable codes on a computer including all data processing apparatus readable recording medium. The computer readable recording medium is any data storage device that can store programs or data which can be thereafter read by a computer system. Examples of the computer readable recording medium include read-only memory (ROM), random-access memory (RAM), CD-ROMs, magnetic tapes, hard disks, floppy disks, flash memory, optical data storage devices, and so on.

According to the present embodiment, the nozzles of a printhead are tested by sensing the voltage of a capacitor or calculating the rate of change of the voltage of the capacitor, the capacitor being used to stabilize the voltage of the power supplied to the printhead for driving the nozzles.

Thus, a mechanical malfunction or damage of the printhead can be prevented and an image forming apparatus having the printhead can be used more safely. Since an abnormal condition of a nozzle or group of nozzles can be detected without using an additional apparatus except for two resistors, manufacturing costs of the printhead can be reduced. Moreover, an additional process to test the nozzles is not needed in the printhead manufacturing process, thereby reducing the manufacturing time.

In addition, as an abnormal condition of the nozzles can be detected easily, the defective nozzle can be compensated for in a set manner, thereby improving printing quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to test a nozzle of a printhead, comprising:
a power supply unit to supply a power to the printhead;
a capacitor to stabilize a voltage of the power supplied to the printhead;
a voltage sensing unit to sense one or more voltages of the capacitor;
a nozzle testing unit test the nozzle using the sensed voltage to detect an abnormal condition of the nozzle; and
a control unit to control the power supply unit and the nozzle.

2. The apparatus of claim 1, wherein the control unit outputs a first control signal to stop supplying the power to the printhead when the sensed one or more voltages is greater than a predetermined voltage and outputs a second control signal to control the driving of the nozzle when a predetermined period of time has passed after outputting the first control signal.

3. The apparatus of claim 2, wherein the nozzle testing unit comprises:
a voltage input unit to receive the sensed voltages of the capacitor before and after the nozzle is driven; and
a defective nozzle detecting unit to detect an abnormal condition of the nozzle using the input voltages.

4. The apparatus of claim 3, wherein the defective nozzle detecting unit detects an abnormal condition of the nozzle using a difference between the voltage sensed before the nozzle is driven and the voltage sensed after the nozzle is driven.

5. The apparatus of claim 4, wherein the defective nozzle detecting unit detects the abnormal condition of the nozzle if the difference between the voltage sensed before the nozzle is driven and the voltage after the nozzle is driven is greater than a critical value.

6. An apparatus to test a nozzle of a printhead, comprising:
a power supply unit to supply a power to the printhead;
a capacitor to stabilize a voltage of the power supplied to the printhead and to transmit the voltage to the printhead;
a rate of change calculating unit to sense the voltage of the capacitor to calculate a rate of change of the voltage of the capacitor; and
a defective nozzle detecting unit to detect an abnormal condition of the nozzle using the calculated rate of change of the voltage.

7. The apparatus of claim 6, wherein the rate of change calculating unit calculates the rate of change of the voltage by sensing the voltage of the capacitor during driving of the nozzle.

8. The apparatus of claim 6, wherein the defective nozzle detecting unit detects the abnormal condition of the nozzle by determining whether an inclination of the calculated rate of change is greater than a critical inclination.

9. A method of testing a nozzle of a printhead of an image forming apparatus including a capacitor to stabilize a voltage of power supplied to the printhead, the method comprising:
supplying power to the printhead;
stopping the supplying of power when a voltage of the capacitor is larger than a predetermined voltage;
measuring voltages of the capacitor before the nozzle is driven and after the nozzle is driven; and
determining whether the nozzle is in an abnormal condition using the measured voltages.

10. The method of claim 9, wherein the determining of whether the nozzle is in the abnormal condition comprises:
determining whether a voltage difference between the voltage measured before the nozzle is driven and the voltage measured after the nozzle is driven is greater that a critical voltage; and
determining that the nozzle is in the abnormal condition if the voltage difference is larger than the critical voltage.

11. A computer readable medium having embodied thereon a computer program for executing the method, the method comprising:
supplying power to the printhead;
stopping the supplying of power when a voltage of the capacitor is larger than a predetermined voltage;
measuring voltages of the capacitor before the nozzle is driven and after the nozzle is driven; and
determining whether the nozzle is in an abnormal condition using the measured voltages.

12. A method of testing a nozzle of a printhead of an image forming apparatus including a capacitor to stabilize a voltage of power supplied to the printhead, the method comprising:
supplying power to the printhead;
stopping the supplying of power when a voltage of the capacitor is larger than a predetermined voltage;
measuring a rate of change of the voltage by driving the nozzle in the printhead; and
determining whether the nozzle is in an abnormal condition using the measured rate of change.

13. The method of claim 12, wherein the determining of whether the nozzle is in the abnormal condition comprises:
comparing an inclination of the measured rate of change and a critical inclination; and
determining that the nozzle is in an abnormal condition when the inclination of the measured rate of change is greater than the critical inclination.

14. A computer readable medium having embodied thereon a computer program for executing the method, the method comprising:
supplying power to the printhead;
stopping the supplying of power when a voltage of the capacitor is larger than a predetermined voltage;
measuring a rate of change of the voltage by driving the nozzle in the printhead; and
determining whether the nozzle is in an abnormal condition using the measured rate of change.

15. An image forming apparatus comprising:
a power supply unit;
a printhead having one or more nozzles;
a capacitor connected between the power supply unit and the printhead to supply a voltage to the printhead; and
a determining unit to determine an abnormal condition of the printhead according to a change of the voltage of the capacitor.

16. The apparatus of claim 15, wherein the change of the voltage is a difference between the voltage before the one or more nozzles are driven and the voltage after the one or more nozzles are driven.

17. The apparatus of claim 15, wherein the change of the voltage is a change of the voltage with respect to a period of time corresponding to a driving period of the one or more nozzles of the printhead.

18. The apparatus of claim 15, wherein the change of the voltage is a rate of change of the voltage with respect to a time variation.

19. The apparatus of claim 15, wherein the change of the voltage comprises one of a forced discharge and a natural discharge.

20. The apparatus of claim 19, wherein the determining unit determines the abnormal condition of the printhead according to the forced discharge and determines a normal condition of the printhead according to the natural discharge.

21. The apparatus of claim 15, further comprising:
a switch connected between the power supply unit and the capacitor to selectively supply the power to the capacitor according to the change of the voltage.

22. An image forming apparatus comprising:
a power supply unit to generate a power;
a printhead having one or more nozzles;
a capacitor unit connected between the power supply unit and the printhead to supply a voltage of the power to the printhead;
a switch unit connected between the power supply unit and the capacitor unit to selectively supply the power to the capacitor according to the voltage of the capacitor unit;
a determining unit to detect a change of the voltage of the capacitor determining unit, and to determine the abnormal condition of the one or more nozzles of the printhead according to the change of the voltage of the capacitor with respect to a predetermined period of time; and
a control unit to control the switch unit and the printhead according to the change of the voltage of the capacitor.
